(19) United States
(12) Patent Application Publication
(10) Pub. No.: US 2003/0210873 A1
(43) Pub. Date: Nov. 13, 2003

(54) Passive alignment connection for fiber optics incorporating VCSEL emitters

(76) Inventor: Anthony L. Moretti, Warenville, IL (US)

Correspondence Address: MOLEX INCORPORATED, 2222 WELLINGTON COURT, LISLE, IL, 60532, US

(21) Appl. No.: 10/142,244

(22) Filed: May 9, 2002

(51) Int. Cl. G02B 6/43

(52) U.S. Cl. 385/89

(57) ABSTRACT

Passive alignment connection between a fiber optic component and a component having one or more vertical cavity surface emitting lasers (VCSELs) is provided. The system includes a VCSEL module which has a VCSEL which emits its optical energy into passive alignment with the fiber optic fiber, as well as a substantially identical VCSEL which emits its optical energy to a detector so as to monitor the optical power of that VCSEL and effectively monitor the optical power of the VCSEL which emits its optical energy in passive alignment with the fiber optic fiber.

### FIELD OF INVENTION

This invention generally relates to laser components in connection with fiber optic systems, especially concerning connection devices and techniques. More particularly, the invention relates to the incorporation of vertical cavity surface emitting laser (VCSEL) technology into fiber optic systems. Included are provisions for passive alignment and for automatically monitoring VCSEL optical power.

### BACKGROUND OF THE INVENTION

In fiber optic transmission systems, signals are transmitted along optical fibers by optical frequency waves (light) generated by sources such as light emitting diode (LED) units, lasers and the like. It often becomes necessary to provide connecting devices which can couple one optical fiber to another. Included are connections between lasers and optical fibers. It is important that the connection between them be in precise alignment so there are no losses or distortions across any connection locations where the light output of lasers needs to be coupled into fiber optic cables.

A traditional procedure for aligning semiconductor lasers to fiber optic connectors of cables utilizes active alignment. When practicing this technique, the laser is turned on so that it is emitting light. Then the fiber optic cable or a fiber optic connector containing a fiber is moved until the power coupled into the fiber is maximized. At this point, the fiber is locked into place. Active alignment is a reliable, but expensive technique because it is time consuming and requires a skilled and experienced technician. It is also a tedious process. Furthermore, in many instances, multiple fibers and/or laser sources are presented in arrays. It will be appreciated that each connection across the array interface must be subjected to such individual active alignment procedures. Thus, the complications and difficulties of active alignment and connection are made all that more difficult because of the serial nature of the work when multiple-component arrays are involved.

An example of units which incorporate an array is fiber optic ribbon cable. Units of this general type provide multiple channels in a single cable structure. An optical ribbon cable is similar to any other well-known ribbon electrical cable to the extent that a plurality of optical fibers or channels are disposed in a line or in a generally coplanar relationship. The individual fibers of such a multi-fiber cable are very thin and extremely fragile. Handling of such fibers can be tedious, such as in inserting a fiber into a single aligning hole or passage. Where a plurality of such fibers from a single cable need to be positioned for alignment, the difficulty is multiplied considerably. For example, if a single fiber of a multiple-fiber cable is broken, the stripped cable end and/or the other component being aligned must be discarded, reworked or both. Processes of this type typically have been carried out by hand, usually requiring an experienced technician and laboratory conditions.

Alignment problems and tolerance problems associated with active alignment techniques are further complicated in connector assemblies wherein a pair of mating connector ferrules themselves are placed into mating condition by two alignment pins. Such alignment pins typically have one end of each pin extending into a passage of one of the connector ferrules, and the opposite end of the pin is inserted into a passage in the mating connector ferrule. Often, a chamfered lead-in on the pin is provided for facilitating alignment. The problems of maintaining precise tolerances with the alignment pins and their passages must be added to the tolerance problems in maintaining precise spacing and alignment between the optical fiber ends and the laser source. Circumstances such as these typically result in a high number of rejects during the practice of the prior art.

An approach which has been found to be useful in the past is using a fiber optic connector ferrule for precisely aligning an array of fibers for alignment with a complementary ferrule. An example of such an approach and of a type of fixture for assembly for same is shown in Bunin et al U.S. Pat. No. 5,907,657, incorporated hereinto by reference. While ferrules of this type are an important advance in the art when it comes to handling fiber optic fiber connections, further improvements are realized according to the present invention, which achieves an advantageously passive alignment requiring no light up or assessment of power into each fiber. The passive alignment approach of the invention is fast, reproducible, easy and cost effective. It is readily accomplished in the field by straightforward component removal and replacement, avoiding the requirement of a laboratory environment which typically requires very expensive alignment equipment.

Somewhat more passive alignment techniques have been proposed for lasers which are of the edge-emitting type. In such approaches, edge-emitting lasers are flip-chip bonded onto silicon substrates into which V-shaped grooves have been precisely etched into the substrate. With this approach, fibers then are placed into the grooves, providing alignment to this type of laser without actively turning on the laser and moving the fiber for optimum alignment.

Approaches such as these cannot be practiced when the laser is of the vertical cavity surface emitting type. Such VCSEL devices add the complication that, when a VCSEL has been flip-chip bonded to a substrate, the VCSEL emits its light perpendicular to the direction of the V-grooves provided for such an alignment by a passive technique of this type. With edge-emitting lasers, the light is emitted parallel to the V-groves, allowing for straight-on alignment not possible for a perpendicular VCSEL emission.

Passive alignment has been proposed for connections involving VCSELs. One such approach uses multi chip module and silicon micromachining technology. Alignment marks on a VCSEL array chip and the base plate in this type of structure are used to position the chip on the base plate. The laser chip is bonded on the silicon base plate using conductive epoxy. A fiber array block, which is a silicon piece having multiple V-grooves and which carries fiber stubs, is epoxied on top of the laser array for transmitting light from the VCSELs to a fiber connector. Light from the laser is coupled into fibers of the fiber array block by the use of mirrors on the ends of the fibers. Such mirrors are formed by angle polishing the fiber pins at 45° and depositing a thick layer of gold film. It will be appreciated that such a gold-plated angled mirror adds its own level of expense and complexity which provides a less-than-satisfactory solution.

One other important difficulty when utilizing VCSELs in a way that allows for suitable automatic passive alignment is the difficulty in incorporating a laser power monitor in view of the perpendicular emission path of a VCSEL. When edge-emitting lasers are used, monitoring is less complicated than for a VCSEL in view of the parallel nature of the emission out of the sides of an edge-emitting laser. When mounted, the edge-emitting laser emission is easily monitored in view of the easy accessibility inherent in this parallel emission.

An example of an electro-optical signal translator which incorporates passive assembly techniques and an edge-emitting laser which is monitored by a photo detector is found in Chambers et al U.S. Pat. No. 5,993,074, incorporated hereinto by reference. Approaches such as these cannot be effectively practiced when the laser emits optical radiation perpendicular to the substrate upon which it was grown. Thus, there is a substantial problem in providing for passive alignment between laser components incorporating VCSELs where there is a need or desire to monitor the lasers.

Monitoring of laser power is very important. Laser power monitoring permits controlling and/or preventing changes in optical power due to changes in the emission characteristics of the laser, which can occur with laser aging and with temperature fluctuation. In addition, power monitoring is very important to eye safety. A monitor will itself report when, for example, a laser light is “out” by virtue of direct feedback from the monitor. This allows the system to be shut down as needed. Providing such a monitoring means would by very advantageous for systems which incorporate VCSEL technology.

### SUMMARY OF THE INVENTION

In accordance with the present invention, passive alignment connection for fiber optics incorporating VCSEL emitters is accomplished using a modular approach. Included is a module containing one or more VCSEL emitters and one or more light-passing passageways for laser emission from the VCSEL source. Each such passageway is provided with respect to a face of the module. This face also includes two or more pin locations, and each light-passing passageway is spaced from the pin locations in accordance with a predetermined alignment pattern which is adapted to coincide with pin locations and at least one fiber optic fiber location of another component with which connection is to be made. With respect to a system according to the invention, that other component is a connector module having at least one fiber optic fiber with an end which is accessible from a face of this connector module. The fiber optic fiber and the pin locations of the connector module are spaced in accordance with the predetermined alignment pattern of the VCSEL module. When the VCSEL module and the connector module are attached together, the fiber optic fiber of the connector module automatically optically aligns with the passageway of the VCSEL module. In accordance with the detection aspect of this invention a chosen monitor VCSEL of the VCSEL module emits optical radiation to a detector which thereby monitors the optical power of that VCSEL.

A passive alignment method also is included which attaches the connector module and the VCSEL module together in order to thereby automatically optically align each VCSEL passageway with each fiber optic fiber. Once thus passively aligned, optical power detection is directly carried out.

It is accordingly a general object of the present invention to provide an improved passive alignment connection for fiber optics incorporating vertical cavity surface emitting lasers.

Another object of the present invention is to provide an improved passive alignment VCSEL module which is readily installed with a fiber optic connector module, the installation of such being readily accomplished in the field and without requiring laboratory conditions or expensive equipment.

Another object of the present invention is to provide an improved system and method having communication between one or more VCSELs and one or more fiber optic fibers and which permit replacement of only damaged or faulty components, or those suspected of being faulty, rather than requiring replacement of an entire assembly.

Another object of this invention is an improved system and an improved method which provide a modular approach to passive alignment connection between a VCSEL and a fiber optic component.

Another object of the present invention is to provide an improved passive alignment module for VCSEL components which includes a detector system that monitors optical power of at least one dedicated monitor VCSEL.

Another object of the present invention is to provide a passive alignment VCSEL module which incorporates at least one VCSEL pair, one VCSEL of the pair being for optical emission for fiber optic connection, with the other VCSEL of the pair providing optical emission to a detector for monitoring optical power of the VCSEL pair.

These and other objects, features and advantages of the present invention will be apparent from and clearly understood through a consideration of the following detailed description.

### BRIEF DESCRIPTION OF THE DRAWINGS

In the course of this description, reference will be made to the attached drawings, wherein:

FIG. 1 is a perspective view of an illustrated embodiment showing a connector or ferrule being passively aligned with a VCSEL module having components and functions according to the invention;

FIG. 2 is a perspective view similar to FIG. 1, but from a generally opposite perspective;

FIG. 3 is a top plan view illustrating in somewhat schematic manner a passively aligned VCSEL module and connector module;

FIG. 4 is an enlarged view of the connection location illustrated in FIG. 3;

FIG. 5 is a view similar to FIG. 4, showing an optional embodiment;

FIG. 6 is a detail view of a typical VCSEL mount and its positioning with respect to its interface with an optical fiber connector;

FIG. 7 is a further enlarged portion of FIG. 6 and the VCSEL mount;

FIG. 8 is a schematic view of typical circuitry of a VCSEL on a submount, showing two mounting pins and two VCSEL units;

FIG. 9 is a schematic view of a typical VCSEL submount; and

FIG. 10 is an illustration of a VCSEL die which is of a type that can be incorporated into the invention.

### DESCRIPTION OF THE PREFERRED EMBODIMENTS

In the embodiment which is illustrated in FIG. 1, a connector receptacle or connector ferrule, generally designated at 21, is in position for aligning assembly with a vertical cavity surface emitting laser module, generally designated at 22. The connector ferrule and the VCSEL module are shown in general mating alignment with each other. This mating alignment facilitates the connection together of the connector ferrule and the VCSEL module that accomplishes passive alignment which is discussed in greater detail elsewhere herein.

The illustrated connector ferrule 21 is an MT ferrule housing an array of twelve optical fibers 23. Ends 24 of these fibers are illustrated at mating face 25. A ferrule body 26 also is shown supporting the mating face 25. Attachment pins are provided either in the connector ferrule or the VCSEL module in order to mate with pin passageways in the other of these components. In the illustrated embodiment, the pins project from the VCSEL module, and the pin passageways or receptors are in the connector ferrule. As shown, two attachment pins 27 project from a face 28 of the VCSEL module. In a typical assembly, each pin 27 is secured within a pin passageway 29, which is in the mating face 25 of the connector ferrule 21.

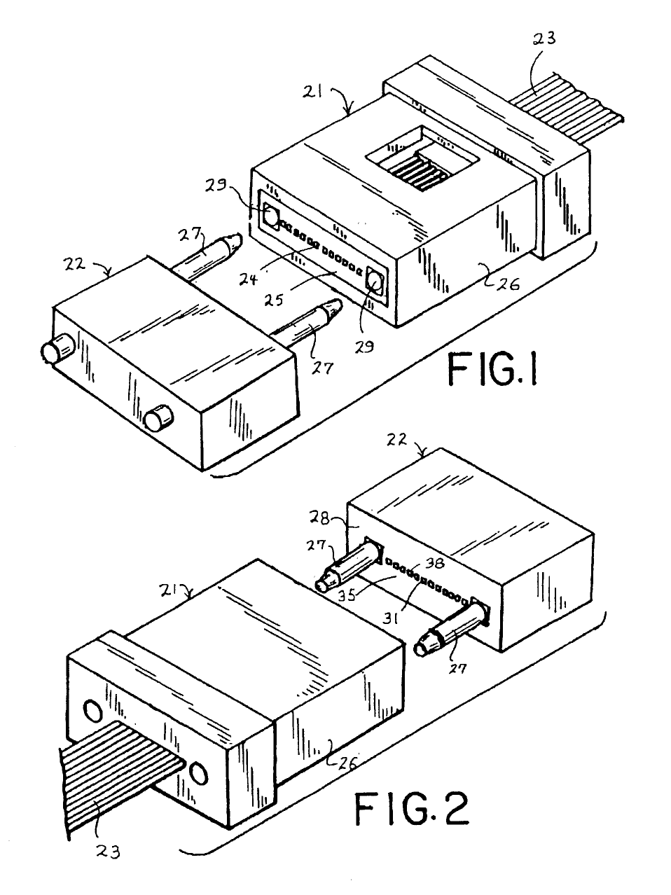

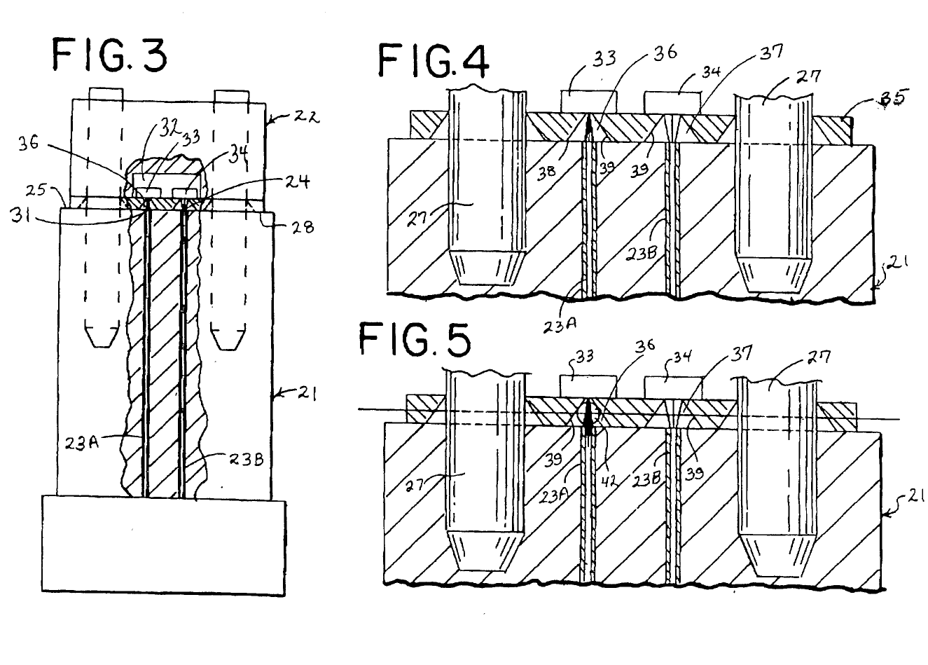

It will be appreciated that the number of optical fibers 23 can vary as required for the particular application in respect of which the equipment is to be used. Respective ends 24 of the optical fibers will align with VCSEL interface areas 31. In the embodiment illustrated in FIGS. 1 and 2, there are 12 VCSEL interface areas 31 in an array, each being in alignment with a fiber end 24 when passive connection has been completed. FIGS. 3 through 9 shown an embodiment having only two VCSEL interface areas 31.

When a transceiver concept is to be practiced, the VCSEL interface areas can be for transmitting optical energy or for receiving optical energy, discussed in greater detail herein. Accordingly, the number and type of VCSEL interface areas can vary. The invention provides automatic or passive alignment of these areas 31 with the fiber ends 24.

It will be appreciated that the various components of the connector ferrule 21 and of the VCSEL module 22 are immovably assembled with respect to each other. Thus, the fiber ends 24 are secured in place, and the pin passageways 29 are accurately positioned in accordance with a predetermined alignment pattern. The connector ferrule is manufactured in accordance with known procedures. For example, a suitable connector receptacle or ferrule can be made in accordance with Bunin et al. U.S. Pat. No. 5,907,651, incorporated by reference hereinto.

This predetermined alignment pattern is provided for the VCSEL module 22. Thus, the interface areas 31 and the attachment pins 27 are secured in place in accordance with this predetermined alignment pattern. Pins preferably are precision cylindrical pins having a round cross-section, a typical standard pin in this regard having a diameter of 700 microns, plus or minus 1 micron.

More particularly, each pin is in alignment with a respective pin passageway, and each interface area 31 is in precise alignment with a respective optical fiber end 24. Preferably, there is center-to-center alignment between the respective optical fiber ends and the energy beam of the VCSEL.

VCSEL module 22 is illustrated as having a typical mechanical mount made according to known precision assembly techniques, including having the attachment pins 27 secured in place with the required proper alignment. In this illustrated mechanical mount arrangement, a cavity 32 is shown in order to provide a location for a mounting of laser components.

A vertical cavity surface emitting laser or VCSEL 33 is shown at this location. Reference number 34 can likewise be a VCSEL. When two VCSELs 33 and 34 are active in passing light energy outwardly from the interface areas 31 and into fibers 23A and 23B, the light energy from each VCSEL moves downwardly according to the orientation of FIG. 3.

For purposes of illustration, reference numeral 34 also represents a known photodetector which is provided for receiving light from its opposing optical fiber. In the illustrated embodiment, this photodetector 34 receives light energy emitted from one of the fiber ends 24 of the connector ferrule 21, and a transceiver approach is followed.

When this transceiver concept is practiced, light transmission will be upwardly according to the FIG. 3 orientation. In that instance a known photodetector 34 receives light from the fiber 23B. Electrical characteristics are transferred in a high speed manner into the receiver or photodetector 34 in this illustrated embodiment.

Each VCSEL is flip-chip bonded to the substrate of the VCSEL module 22. This is accomplished in accordance with well-known procedures. When thus bonded, the VCSEL emits its light energy in a perpendicular direction, which is in a downward orientation as in FIG. 3 through FIG. 5. A substrate at the face 28 of VCSEL module 21 typically is made of epoxy material of generally known composition for optic connector uses. Each pin 27 is mounted therethrough, as perhaps best seen in FIG. 4 and FIG. 5.

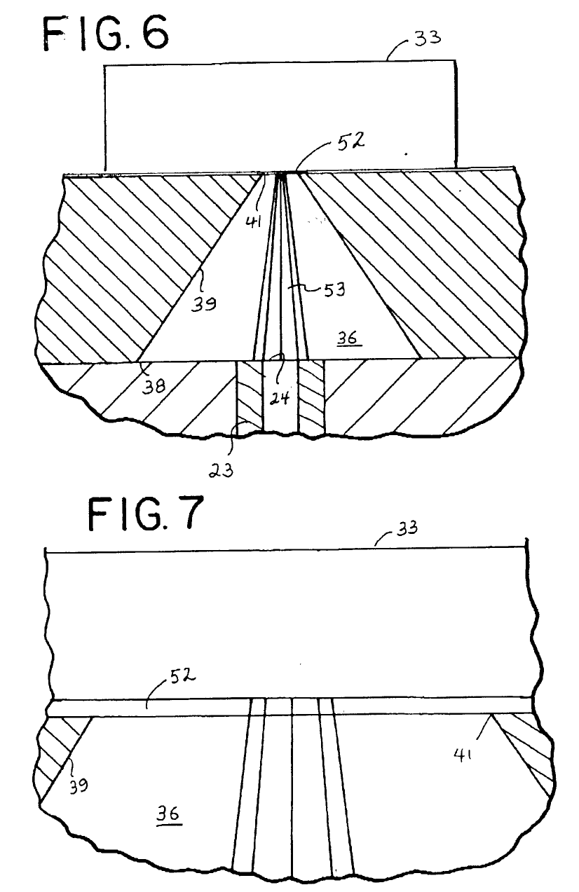

In addition, substrate 35 includes a plurality of openings 36, 37. In this illustrated embodiment, each opening has a generally pyramid shape, including a rectangular mouth 38 and inwardly tapering sidewalls 39. This structure provides a narrow aperture 41 which opens into the mouth 38. These are perhaps best seen in FIG. 6 and FIG. 7. As generally seen in FIG. 6, the light energy emission from VCSEL 33 is directed into the optical fiber 23.

On occasion, it might be desirable to focus down the VCSEL emission beam. In this instance, a suitable member, such as the illustrated microball lens 42 may be inserted into the opening 36, 37. Such lenses are generally known in the art.

A further detailed illustration of a VCSEL submount for carrying out the monitoring features of the invention is shown beginning in FIG. 3. VCSEL 33 is connected to suitable circuitry. FIG. 8 views the unit from the back side of the VCSEL, generally looking down onto the top or apex of the generally pyramid-shaped opening 36. The illustrated circuitry takes the form of electrical traces 44, 45, 46, 47. Formation of these traces is carried out by generally known procedures such as metal/silicon/metal photolithography. The electrical traces shown are intended to depict typical circuitry for these types of devices. In addition to VCSEL 33, a photodetector 34 is illustrated to provide a transceiver arrangement as discussed herein.

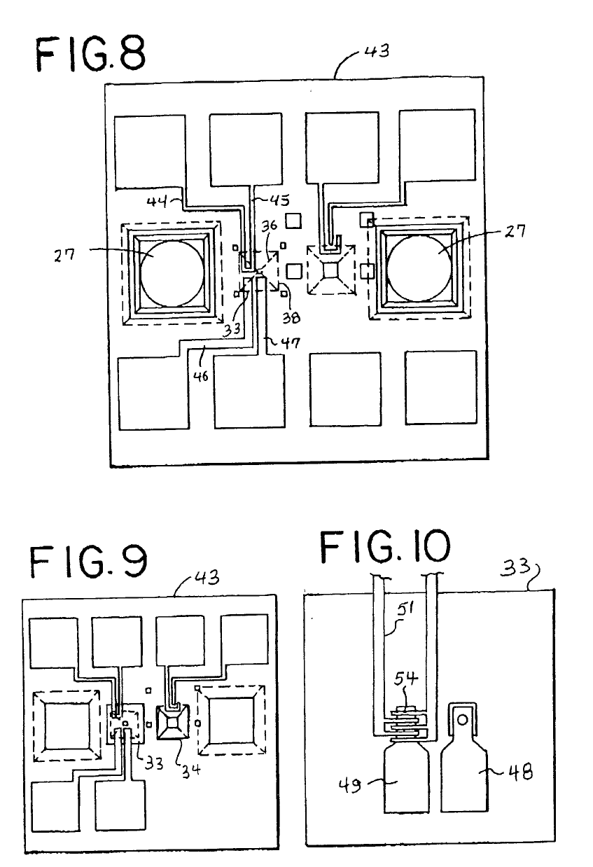

The VCSEL 33 shown in FIG. 9 is in the nature of a VCSEL die having two VCSEL emitters 48 and 49. VCSEL emitter 48 functions as a transmitter. Its optical energy transmits information into a corresponding optical fiber in accordance with the passive connection accomplished by this invention. VCSEL emitter 49, which is a virtual twin of VCSEL transmitter 48, functions as a power control detector by which the energy properties of all of the VCSELs in the particular selected array are monitored. Electrical traces 51 connect to known monitor means 54 in order to observe and note any changes in energy at this power control detector 49.

By this arrangement, the invention adds a power control monitor in the VCSEL optical path without affecting the connection and paths of alignment between the VCSEL module and the connector ferrule. This power monitoring approach allows detection of changes in optical power due to environmental or operational temperature changes and/or due to laser aging and other modifications which vary the emission characteristics of the laser. This allows one to make necessary adjustments in order to control or offset these types of variations in emission characteristics.

The monitoring accomplished by the invention also achieves increased eye safety. The monitor 54 detects when there is a laser failure, enabling system shut down without requiring visual inspection and the possibility of eye damage.

With the present invention, the power control detector 48 is formed onto the silicon surface. This extra VCSEL need not have its perpendicular light energy emission directed out of the VCSEL module for passive alignment with a fiber end; instead, the perpendicular light energy is monitored head on.

Because the power control detector VCSEL 48 and the energy transmission VCSEL (one or more) are virtually identical, each will mature according to substantially the same timetable, and each will respond to environmental, temperature and electrical changes in a substantially identical manner. Thus, observing properties of the power control detector VCSEL 48 gives the properties of each VCSEL which is in passive alignment with an optical fiber when the optical connection is made. If desired, a single power control detector VCSEL can be used for monitoring multiple VCSEL arrays, including those having, for example, 4, 8, 12 or more channels. With the present invention, power monitor diodes are incorporated into the optical path of a VCSEL emitter.

It can be desirable to impart protection to the VCSEL. In some applications, moisture due to washing or handling could potentially come into contact with the VCSEL, thereby potentially negatively affecting the VCSEL. Membrane technology can be practiced in this regard. Implementation of such membrane technology is illustrated in FIG. 6 and FIG. 7.

With the arrangement illustrated, moisture could contact the VCSEL 33 by passing through aperture 41. A membrane 52 is shown at this location. If desired, as illustrated, this membrane can extend the full active face of VCSEL 33. Suitable membrane materials are silicon dioxide and silicon nitride protection layer(s). As illustrated, laser light rays 53 pass from the VCSEL 33, through the protective membrane 52, into the opening 36, and into the optical fiber 23 of the connector ferrule.

Openings 36, 37 are prepared by the use of precision-etched silicon. These precision holes are etched into the silicon both for the VCSEL light emission and for the guide pins. The detectors also are formed onto the silicon surface. All of these VCSEL emitters except for the power control detector are aligned to the etched holes in the silicon. The “extra” VCSEL is automatically pointed at the silicon detector. A typical VCSEL die size is approximately 600 microns by 600 microns, while a typical VCSEL submount is about 4 mm by 4 mm by 0.25 mm.

After attachment pins 27 are inserted into pin passageways 29, there is passively achieved precise center-to-center alignment of each VCSEL 33 with each respective optical fiber end 24. Whole array registry of these respective ends is facilitated by center-to-center alignment of the respective attachment pins and pin passageways, in conjunction with a precise sizing of the pins and pin passageways which allows for sliding insertion while avoiding play or movement of the pins within the pin passageways.

Preferably, the ends 24 of the fibers 23, and thus the fiber cores and fiber bodies, do not project beyond the mating face 25 of connector ferrule 21. This helps to protect the fibers and to assure that they remain in the predetermined alignment pattern because they are fully supported by the mating face. Typically, the ends are flush with the mating face, and the fibers are imbedded within the connector 21.

### EXAMPLE

In order to illustrate the monitoring aspect of the invention, a VCSEL die subassembly was constructed to have the VCSEL die suspended between two submount assemblies so that there was VCSEL aperture alignment. An MSM power monitor was used to detect changes in laser drive current of the VCSEL.

When the laser was subjected to a drive current of 3 mA, the photodiode current of the MSM power monitor was 10 μA. With the laser on at 4 μA, the photodiode current was 13 μA. With the laser on at 5 mA, the photodiode current was 15 μA. With the laser on at 6 mA, the photodiode current was 18 μA. With the laser on at 7 mA, the photodiode current was 21 μA. With the laser on at 8 mA, the photodiode current jumped to 95 μA. With the laser on at 9 mA, the photodiode current was 230 μA. With the laser on at 10 mA, the photodiode current was 410 μA. With the laser on at 11 mA, the photodiode current was 590 μA. With the laser on at 12 mA, the photodiode current was 720 μA. With the laser on at 13 mA, the photodiode current was 830 μA (4.67V). With the laser on at 14 mA, the photodiode current was 998 μA (4.57V). With the laser on at 15 mA, the photodiode current was 1111 μA (4.48V). With the laser on at 16 mA, the photodiode current was 1200 μA. With the laser on at 17 mA, the photodiode current was 1330 μA (4.37V). With the laser on at 18 mA, the photodiode current was 1450 μA. With the laser on at 19 mA, the photodiode current was 1580 μA. With the laser on at 20 mA, the photodiode current reached 1710 μA.

These data show a correlation between the monitored current and the laser drive current, thereby illustrating the effectiveness of the monitoring principle. This showed a relationship between output power versus drive current for the VCSEL.

It will be understood that the embodiments of the present invention which have been described are illustrative of some of the applications of the principles of the present invention. Numerous modifications may be made by those skilled in the art without departing from a true spirit and scope of the invention.

1. A passive alignment vertical cavity surface emitting laser (VCSEL) module, comprising:
a module body having a face;
a plurality of vertical cavity surface emitting lasers (VCSELs) supported by said module body;
at least one light-passing passageway of said face of the module body, and at least one of said VCSELs emits optical energy through said light-passing passageway;
another of said VCSELs is a monitor VCSEL which emits optical energy to a detector, which detector monitors optical power of that VCSEL to provide a power control detector;
at least two pin locations; and
said light-passing passageway is spaced from said pin locations of the VCSEL module in accordance with a predetermined alignment pattern which is adapted to coincide with pin locations and at least one fiber optic fiber of another component.

2. The VCSEL module in accordance with claim 1, wherein said predetermined alignment pattern coincides with an alignment pattern of a connector module having at least two pin locations and a plurality of fiber optic fibers having ends terminating in a face thereof, wherein each of said respective VCSELs are adapted to optically align with each of the respective fiber ends.

3. The VCSEL module in accordance with claim 1, wherein said alignment pattern is center-to-center alignment.

4. The VCSEL module in accordance with claim 1, wherein said VCSELs are flip-chip bonded onto a silicon-containing substrate having an opening in center-to-center alignment with laser emission of each said VCSEL which emits optical energy through the light-passing passageway.

5. The VCSEL module in accordance with claim 1, wherein said VCSELs are flip-chip bonded onto a substrate having a generally pyramid-shaped opening in alignment with each emission path of each said respective VCSELs.

6. The VCSEL module in accordance with claim 1, wherein said VCSELs are mounted at said module body face in accordance with said predetermined alignment pattern.

7. The VCSEL module in accordance with claim 1, wherein said monitor VCSEL is substantially identical with each VCSEL which emits optical energy through said light-passing passageway.

8. The VCSEL module in accordance with claim 7, wherein said monitor VCSEL has substantially the same energy life as each said VCSEL which emits optical energy through the light-passing passageway.

9. The VCSEL module in accordance with claim 1, further including a microball lens within the module and which receives and passes VCSEL optical energy through the light-passing passageway.

10. The VCSEL module in accordance with claim 1, further including a protective membrane between at least one of said VCSELs and its light-passing passageway.

11. A system for passive alignment connection between a fiber optic component and a vertical cavity surface emitting laser (VCSEL) component, comprising:
a connector module having at least one fiber optic fiber with an end that is accessible from a face of said connector module;
a VCSEL module having a face with at least one light-passing passageway and having a plurality of vertical cavity surface emitting lasers (VCSELs) supported by the VCSEL module, and at least one of said VCSELs emits optical energy through said light-passing passageway;
another of said VCSELs of the VCSEL module is a monitor VCSEL which emits optical energy to a detector which monitors optical power of that VCSEL;
at least two pins projecting from one of said modules at pin locations;
at least two pin passageways within another of said modules at pin locations at said face thereof, said respective pin passageways being sized, shaped and positioned to received respective said projecting pins; and
said end of the fiber optic fiber is spaced from said pin locations of the connector module in accordance with a predetermined alignment pattern, and said face passageway of the VCSEL module is spaced from said pin locations of the VCSEL module in accordance with said predetermined alignment pattern, whereby said end of the fiber optic fiber of the connector module optically aligns with said face passageway of the VCSEL module when said modules are attached together.

12. The system in accordance with claim 11, wherein, when said modules are attached together, each said VCSEL which emits optical energy through the light-passing passageway is in center-to-center alignment with a respective said end of the fiber optic fiber.

13. The system in accordance with claim 11, wherein said end of the fiber optic fiber is flush with said face of the connector module.

14. The system in accordance with claim 11, wherein said VCSELs are flip-chip bonded onto a silicon-containing substrate having an opening in center-to-center alignment with laser emission of each said VCSEL which emits optical energy through the light-passing passageway.

15. The system in accordance with claim 11, wherein said VCSELs are flip-chip bonded onto a substrate having a generally pyramid-shaped opening in alignment with each emission path of each said respective VCSELs.

16. The system in accordance with claim 11, wherein said VCSELs are mounted at said module body face in accordance with said predetermined alignment pattern.

17. The system in accordance with claim 11, wherein said monitor VCSEL is substantially identical with each VCSEL which emits optical energy through said light-passing passageway.

18. The system in accordance with claim 11, wherein said monitor VCSEL has substantially the same energy life as each said VCSEL which emits optical energy through the light-passing passageway.

19. The system in accordance with claim 11, further including a microball lens within the module and which receives and passes VCSEL optical energy through the light-passing passageway.

20. The system in accordance with claim 11, further including a protective membrane between at least one of said VCSELs and its light-passing passageway.

21. A method for passive optical alignment of a system for connection between a fiber optic component and a vertical cavity surface emitting laser (VCSEL) component, comprising the steps of:
providing a connector module having at least one fiber optic fiber having an end terminating at a face of the connector module and having at least two pin locations;
spacing said end of the fiber optic fiber and said pin locations in accordance with a predetermined alignment pattern;
providing a VCSEL module having at least one light-passing passageway and a plurality of vertical cavity surface emitting lasers (VCSELs), at least one of said VCSELs emits optical energy through the face passageway, and another of said VCSELs is a monitor VCSEL which emits optical energy through other than said face, said VCSEL module having at least two pin locations;
spacing said VCSEL module face passageway and said pin locations of the VCSEL module in accordance with said predetermined alignment pattern;
attaching the connector module and the VCSEL module together in order to thereby automatically optically align each VCSEL passageway with each fiber optic fiber when the modules are attached together; and
monitoring the optical energy of the monitor VCSEL.

22. The method in accordance with claim 21, wherein said attaching step automatically aligns the fiber optic fiber end in center-to-center alignment with the optical energy path of the VCSEL which emits its optical energy through the light-passing passageway.

23. The method in accordance with claim 21, wherein said providing of a VCSEL module includes flip-chip bonding of the VCSEL for alignment with the light-passing passageway.

24. The method in accordance with claim 21, wherein said monitoring step detects changes in optical energy of the monitor VCSEL in order to thereby detect like changes in said VCSEL which emits optical energy through the light-passing passageway.
